(19) United States
(12) Patent Application Publication
(10) Pub. No.: US 2004/0119417 A1
(43) Pub. Date: Jun. 24, 2004

(54) Scanner with common illumination light source

(76) Inventor: Hsiu-O Hsu, Hsin-Chu City (TW)

Correspondence Address: NATH & ASSOCIATES, 1030 15th STREET, 6TH FLOOR, WASHINGTON, DC, 20005, US

(21) Appl. No.: 10/323,970

(22) Filed: Dec. 20, 2002

(51) Int. Cl. H05B 37/02

(52) U.S. Cl. 315/169.3; 315/149

(57) ABSTRACT

The present invention provides a common illumination light source to replace the conventional backlight source as the light source in the scanner. The present invention is according to the identity of the document sheet (transparent or reflected) that the “ON” or “OFF” of the linear light emitting diode arrays is controlled by the computer program to perform the scanning process. Further, the backlight module utilized the light guide device to collect the illuminating light that is emitted from the linear emitting diode arrays, and the illuminating light reflected through the document sheet to the image sensor device by the reflected mirror module. Thus, the scanner utilized the common illumination light as the light source to illuminate the document sheet that can reduce the cost of lamp holder and obtain the better outputting image data quality.

### BACKGROUND OF THE INVENTION

1. Field of the Invention

The present invention generally relates to a common illumination device for a scanner apparatus, and more particularly to a computer program controls a common illumination device to illuminate the reflected or transparent document sheet.

2. Description of the Prior Art

Scanner devices, such as flatbed scanners, are well known in the art and produce machine-readable image data signals that are representative of a scanned object, such as a photograph or a page of printed text. In a typical scanner application, the image data signals produced by a scanner may be used by a personal computer to reproduce an image of the scanned object on a suitable display device, such as a CRT or a printer.

A typical flatbed scanner may include illumination and optical systems to accomplish scanning of the object. The illumination system illuminates a portion of the object (commonly referred to as a “scan region”), whereas the optical system collects light reflected by the illuminated scan region and focuses a small area of the illuminated scan region (commonly referred to as a “scan line”) onto the surface of a photosensitive detector positioned within the scanner. Image data representative of the entire object then may be obtained by sweeping the scan line across the entire object, usually by moving the illumination and optical systems with respect to the object.

By way of example, the illumination system may include a light source (e.g., a fluorescent or incandescent lamp or an array of light emitting diodes (LEDs)). The optical system may include a lens and/or mirror assembly to focus the image of the illuminated scan line onto the surface of the detector. Alternatively, a “contact image sensor” (CIS) may be used to collect and focus light from the illuminated scan region onto the detector.

The photosensitive detector used to detect the image light focused thereon by the optical system may be a charge-coupled device (CCD), although other devices may be used. A typical CCD may comprise an array of individual cells or “pixels,” each of which collects or builds-up an electrical charge in response to exposure to light. Since the quantity of the accumulated electrical charge in any given cell or pixel is related to the intensity and duration of the light exposure, a CCD may be used to detect light and dark spots on an image focused thereon.

While flatbed scanners are well known and are being used, they tend to have a rather large “footprint” thus occupy a substantial amount of space wherever they may be placed (e.g., a desk or a table). Further, since most flatbed scanners need to be connected to various external devices (e.g., wall outlets and personal computers) by one or more cords and cables, most users tend to resist moving the scanner unless absolutely necessary. Indeed, many users tend to regard flatbed scanners as “fixtures” on the desk or table on which they are placed.

FIG. 1 is a flow chart that represents the double image problem, which is generated by scanning the reflected/transparent document sheet. The conventional scanner utilized the fluorescent or incandescent lamp as the light sources (step 101). Then, the document sheet such as text or photography is placed on the scanning platen (step 102); herein the document sheet is transparent document sheet in this discussion. When the light source illuminated the transparent document sheet, the stream of light will pass through the transparent document sheet to the backlight device (from down to up), wherein the backlight module within the up housing. Therefore, the stream of light will reflect to the image sensor device (step 103) by the reflected mirror module to generate the outputting image data (step 104), and then outputted the image data of the transparent document sheet (step 105), wherein the reflected mirror module is within the backlight device. Nevertheless, the double image problem will cause by the stream of light pass the transparent document sheet (down to up) and then reflected the stream of light to the image sensor device (up to down), so as to make the image outputted quality is poor.

In order to solve the double image problem during scanning the transparent document sheet, another solution method as depicted in FIG. 2 provides a shading treatment on the central portion of the lamp to reduce the double image problem. As the abovementioned, the fluorescent lamp is used as the light source (step 201) for scanning document sheet. Then, a shading treatment performed to the central portion of the fluorescent lamp (step 202). Thus, the illuminating light can be obtained from the two sides of the fluorescent lamp to scan and illuminate the document sheet. The outputting image data without double image problem (step 205) that is due to the light passed through the transparent document sheet to the backlight device (step 203), and reflected to the image sensor device by reflected module (step 204). Nevertheless, the shading treatment will increase the design cost of the lamp holder. Furthermore, the outputting quality of the image data is decreased due to the fluorescent lamp only provide the illumination light of the two sides, if the illumination is enough to illuminate the document sheet so that the outputting image data quality is reduced. Therefore, the shading treatment can improved the problem of the double image, but the outputting image data quality cannot be improved to the light source relatively that is obtained from the two sides of the fluorescent lamp.

Moreover, the FIG. 3 shows the scanning device 300 with shading treatment mechanism. The fluorescent lamp 302 is treated with shading treatment in the central portion 304 that placed in the chassis (not shown in FIG. 3), the purpose of the shading treatment is due to the double image will be generated from the stream of light 316 that reflected by the reflected mirror module 314 in the backlight device 312 through the transparent document sheet 306 to the image sensor device (not shown in FIG. 3) during scanning transparent document sheet 306. Furthermore, the two sides of the fluorescent lamp 302 used as an illumination light source for scanning transparent document sheet 306.

### SUMMARY OF THE INVENTION

It is an object of this invention is that a computer program used to determine the identity of the document sheet to control the “ON” or “OFF” for the linear light emitting diode arrays as the illuminating light source.

It is another object of this invention to reduce the design cost of the lamp holder with the linear light emitting diode arrays, which has individually emitting light property, and the illumination light source

It is still an object of this invention is that a light guide device installed on the backlight device used to collect the stream of light which is emitted from the linear light emitting diode arrays to scan the transparent document sheet.

According to abovementioned objects, the present invention provides a common illumination light source to replace the conventional backlight source as the light source in the scanner. The present invention is according to the identity of the document sheet (transparent or reflected) that the “ON” or “OFF” of the linear light emitting diode arrays is controlled by the computer program to perform the scanning process. Further, the backlight module utilized the light guide device to collect the illuminating light that is emitted from the linear emitting diode arrays, and the illuminating light reflected through the document sheet to the image sensor device by the reflected mirror module. Thus, the scanner utilized the common illumination light as the light source to illuminate the document sheet that can reduce the cost of lamp holder and obtain the better outputting image data quality.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow diagram showing the step for forming double image by using conventional scanner to scan transparent document sheet in accordance with the conventional prior art;

FIG. 2 is a flow diagram showing the steps for using shading treatment in the central portion of the fluorescent lamp of the scanner in accordance with the conventional prior art;

FIG. 3 is schematic representation of the fluorescent lamp used the shading treatment in accordance with the conventional prior art;

FIG. 4 is a flow diagram showing the steps for using the computer program determines the transparent document to control the “ON” or “OFF” for the linear light emitting diode arrays in accordance with the method disclosed herein;

FIG. 5 is a block diagram representation of the scanner with the scanning module; and

FIG. 6 is schematic representation of the linear light emitting diode arrays as the common illumination light source for scanner.

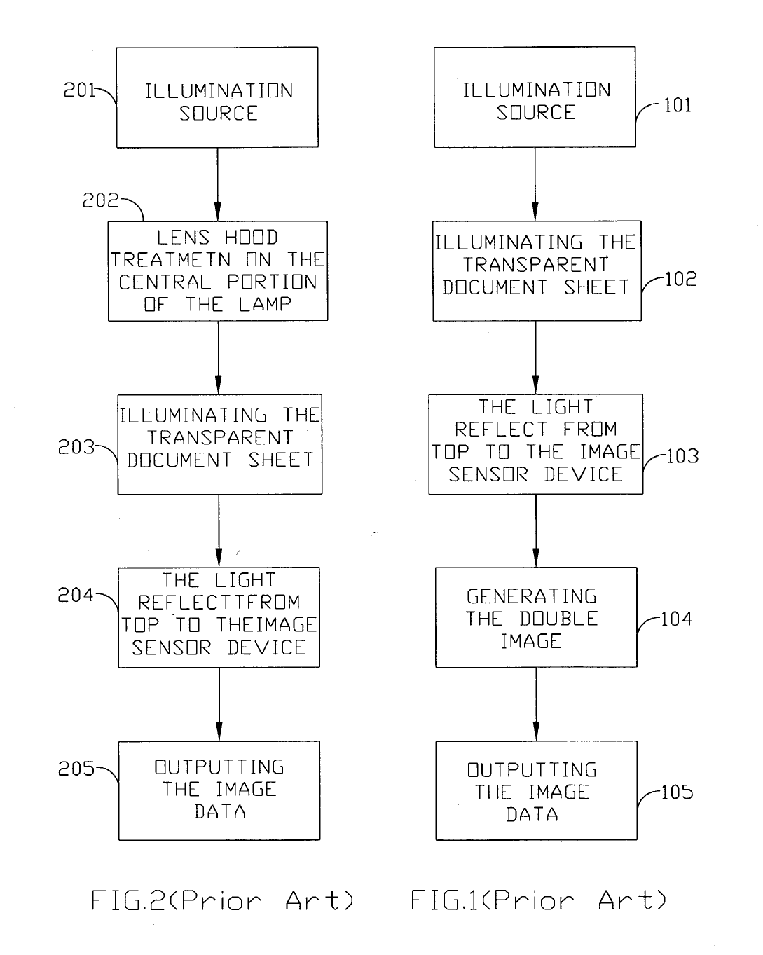

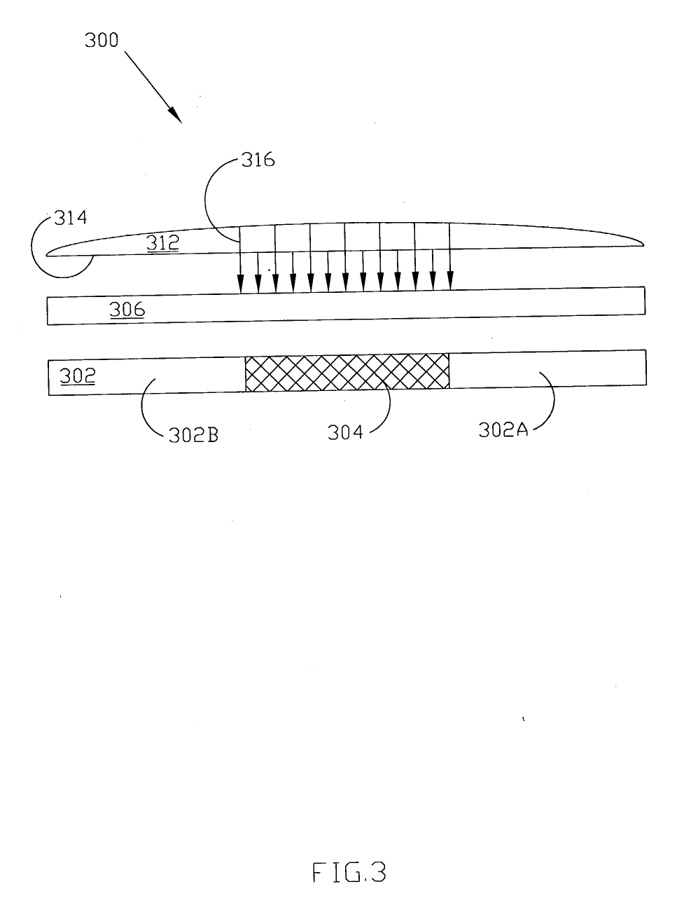

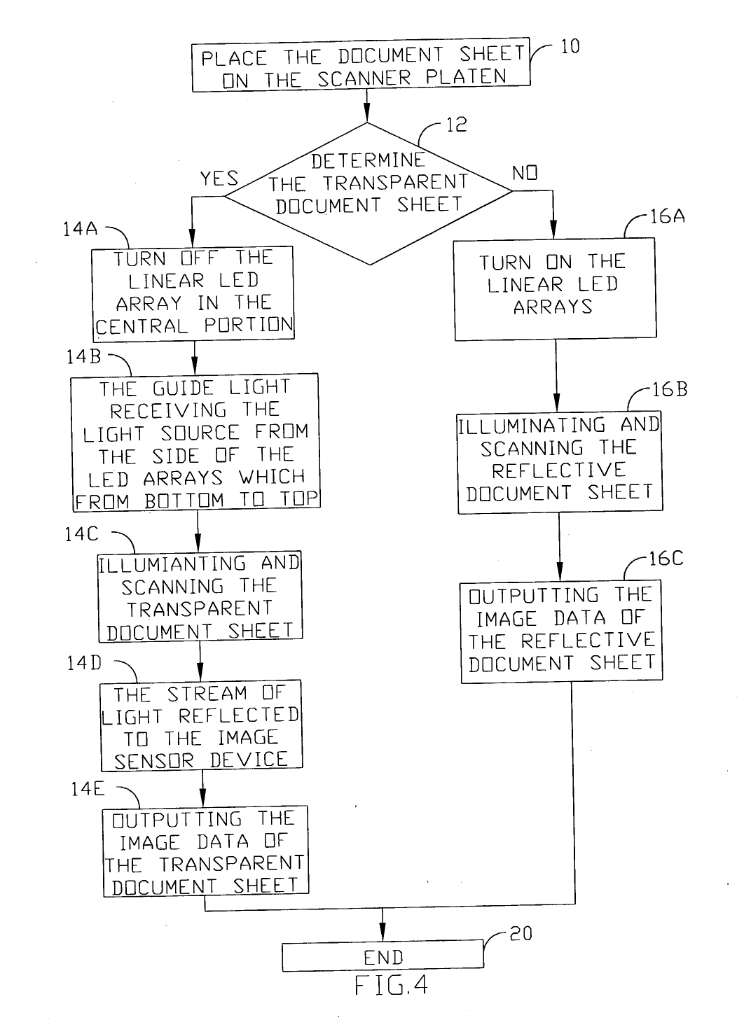

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to the conventional scanner with the fluorescent lamp as the illumination light source will cause the double image problem during scanning transparent document sheet, and in order to reduce the design cost of the lamp holder during the scanner in manufacturing the scanner. Thus, the present invention provides a method to diminish the energy consumption and will not be used the shading treatment to improve the double image problem.

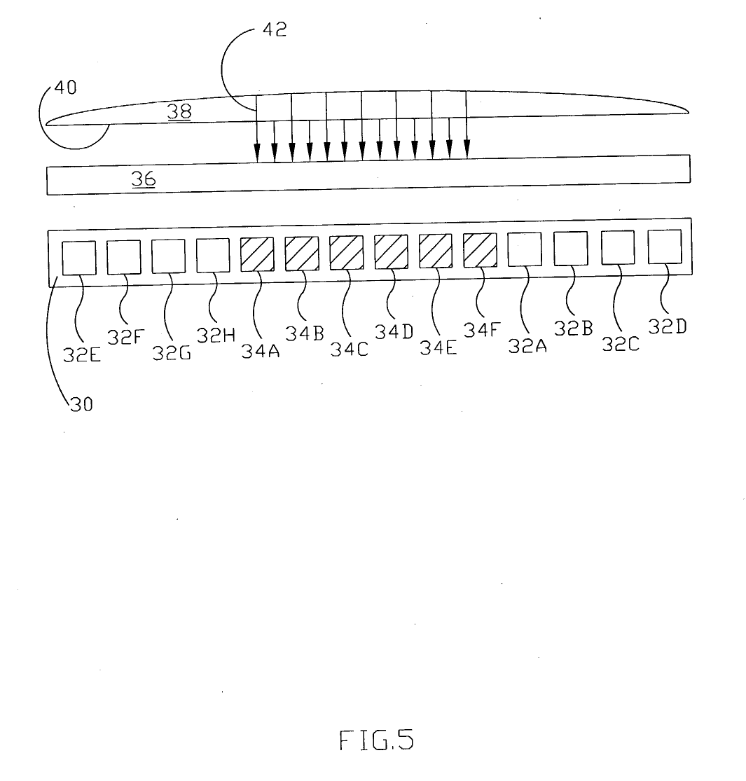

Referring to FIG. 4, a flow chart for showing the linear light emitting diode array as the light source to illuminate the document sheet, and the computer program is utilized to determine the document sheet to control the “ON” or “OFF” for the linear light emitting diode arrays. In the FIG. 4, the document sheet is placed on the scanning platen (step 10). Then, the computer program determined the transparent or reflected document sheet, and controlled the “ON” or “OFF” for the linear light emitting diode arrays (step 12).

When the document sheet is reflected document sheet, the linear light emitting diode arrays exhibit is switched to “ON” by computer program (step 16A). Then, the image data is transmitted to the image sensor device, and is outputted the image data (step 16C), after scanning the reflected document sheet (step 16B). Else, when the document sheet is transparent document sheet, the central portion of the linear light emitting diode arrays is switched to “OFF” by computer program (step 14A). Then, the light source of the two sides of the linear light emitting diode arrays is transmitted from down to up and passed through the transparent document sheet to the light guide device, wherein the light guide device can be a conduct light device. Then, the light guide device collected the light source from the two sides of the linear light emitting diode arrays (step 14B), and the stream of light is reflected to the transparent document sheet to scan (step 14C) by the reflected mirror module, wherein the reflected mirror module is within the backlight device. Next, the stream of light is transmitted the image data from up to down to the image sensor device (step 14D), and then the image data is transmitted to the image device to output the scanning transparent document sheet (step 14E.)

According to the abovementioned, the scanner utilized computer program controls the switch of the central portion of the linear light emitting diode arrays to accomplish the shading treatment to improve the double image problem during scanning the transparent document sheet. Thus, the design cost of the lamp holder can be diminished. Furthermore, the backlight source can be omitted due to the light guide device can collect the stream of light of the two sides of the linear light emitting diode arrays from down to up, and reflected the stream of light that passed through the transparent document sheet to the image sensor device. In addition, the size and space of the scanner can be shrunk and the energy consumption also can be decreased.

Referring to FIG. 5, it is showing a structure of the scanner with a linear light emitting diode arrays as the illumination light source. In the FIG. 5, the central portion 34 A through 34F of the linear light emitting diode arrays 30 is switched to “OFF” which is controlled by computer program to obtain the shading effect. But the two sides 32A through 32D (left side), 32E through 32H (right side) of the linear light emitting diode arrays is switched to “ON”. The light guide device 40 will collect the stream of light of two sides of the linear light emitting diode arrays during the emitted stream of light passed through the transparent document sheet 36 to the backlight device 38. Then, the stream of light 42 is reflected by the reflected mirror module (not shown in FIG. 5.) The double image problem will not be generated during the reflected stream of light 42 passed through the transparent document sheet and transmitted to the image sensor device (not shown in FIG. 5.)

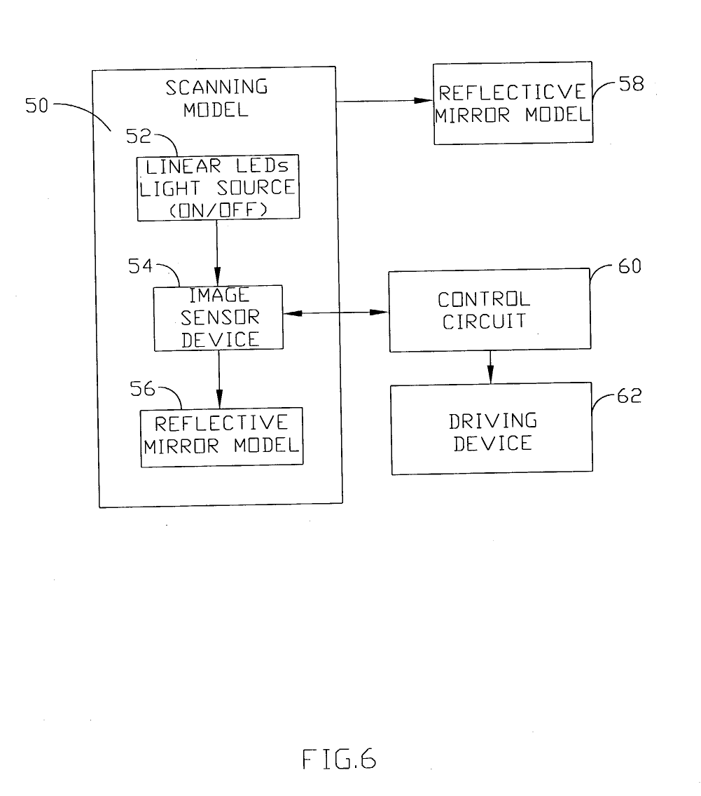

Referring to FIG. 6, a system control block diagram for showing a scanner with a linear light emitting diode arrays. A scanning module 50 includes a illumination light source 52 such as linear light emitting diode arrays. The computer program will control the switch the “ON” or “OFF” of the linear light emitting diode arrays that depend on the transparent or reflected document sheet. Then, the image data is transferred to the reflected module 58 and image sensor device 54, wherein the image sensor device 54 can be CCD (charge-coupled device) or CIS (contact image sensor). Herein, control circuit 60 can control the image sensor device 54 and the control circuit is controlled by drive device 62.

According to abovementioned, we can obtain the several advantages for the scanner with the linear light emitting diode arrays to scan the transparent or reflected document sheet as following:

Firstly, the linear light emitting diode arrays has emitting light by itself that can control the switch of the linear light emitting diode arrays to accomplish the shading effect to improve the double image problem during scanning process.

Secondly, the backlight light source can be omitted due to the light guide device and linear light emitting diode arrays to use a common illumination light source to illuminate the transparent or reflected document sheet.

Thirdly, the design cost of the lamp holder can be reduced due to the linear light emitting diode arrays as the illumination light source for scanner.

Although specific embodiments have been illustrated and described, it will be obvious to those skilled in the art that various modifications may be made without departing from what is intended to be limited solely by the appended claims.

What is claimed is:

1. A method for using the computer program to control the illumination light source, said method comprising:
determining a document sheet is a transparent document sheet;
turning off central portion of an illumination light source;
illuminating said document sheet; and
outputting an image data of said document sheet.

2. The method according to claim 1, wherein said illumination light source comprises a linear light emitting diode arrays.

3. The method according to claim 1, wherein said illuminating said document sheet comprises:
collecting said illumination light source from down to up;
reflecting said illumination light source; and
receiving said illumination light source from said reflected said illumination light source.

4. The method according to claim 3, wherein said collecting said illumination light source comprises a light guide device.

5. The method according to claim 3, wherein said reflecting said illumination light source comprises a reflected mirror module.

6. The method according to claim 3, wherein said receiving said illumination light source comprises an image sensor device.

7. The method according to claim 6, wherein said image sensor device comprises a contact image sensor.

8. The method according to claim 6, wherein said image sensor device comprises a charge coupled device.

9. A scanning device with a common illumination light source, said scanning device comprising:
a illuminating means, said illuminating means for illuminating a document sheet;
a collecting means, said collecting means for collecting an emitting light from said illumination means;
a reflecting means, said reflecting means for reflecting said emitting light; and
a receiving means, said receiving means for receiving said emitting light, wherein said emitting light passed through said document sheet.

10. The scanning device according to claim 9, wherein said illuminating means is a linear light emitting diode arrays.

11. The scanning device according to claim 10, wherein said linear light emitting diode arrays controlled by a computer program.

12. The scanning device according to claim 9, wherein said document sheet comprises a transparent document sheet.

13. The scanning device according to claim 9, wherein said collecting means is a light guide device.

14. The scanning device according to claim 9, wherein said reflecting means is a reflected mirror device.

15. The scanning device according to claim 9, wherein said receiving means is an image sensor device.

16. The scanning device according to claim 15, wherein said image sensor device comprises a contact image sensor.

17. The scanning device according to claim 15, wherein said image sensor device comprises a charge coupled device.

18. A method for using a common illumination light source, said method comprising:
placing a transparent document sheet on a scanning platen;
illuminating said transparent document sheet to obtain an illumination light source, wherein said illumination light source passed from down to up;
collecting said illumination light source;
reflecting said illumination light source, wherein said illumination light source passed through said transparent document sheet to obtain an image data;
receiving said image data; and
outputting said image data.

19. The method according to claim 18, wherein said illuminating said transparent document sheet comprises a linear light emitting diode arrays.

20. The method according to claim 19, wherein said linear light emitting diode arrays controlled by a computer program.

21. The method according to claim 18, wherein said collecting said illumination light source comprises a light guide device.

22. The method according to claim 18, wherein said reflecting said illumination light source comprises a reflected mirror device.

23. The method according to claim 18, wherein said receiving said image data comprises an image sensor device.

24. The method according to claim 23, wherein said image sensor device comprises a contact image sensor.

25. The method according to claim 23, wherein said image sensor device comprises a charge coupled device.
